(19) United States
(12) Patent Application Publication
(10) Pub. No.: US 2016/0011578 A1
(43) Pub. Date: Jan. 14, 2016

(54) ENGINEERING TOOL

(71) Applicants: Kenji TOBORI, (US); Shinsuke KAWASAKI, (US)

(72) Inventors: Kenji TOBORI, Tokyo (JP); Shinsuke KAWASAKI, Tokyo (JP)

(73) Assignee: Mitsubishi Electric Corporation, Tokyo (JP)

(21) Appl. No.: 14/772,840

(22) PCT Filed: Mar. 26, 2013
(86) PCT No.: PCT/JP2013/058754

§ 371 Date: Sep. 4, 2015

(51) Int. Cl. G05B 19/05

(52) U.S. Cl. CPC G05B 19/058; G05B 2219/14097

(57) ABSTRACT

Included are a connection monitoring unit that monitors the presence of connection with a PLC (Programmable Logic Controller) constituting a PLC system, and that, upon detection of connection with the PLC, acquires data related to the state of the PLC system; a function-selecting-screen display unit that displays a list of functions that can be used for searching for an error according to the state of the PLC system acquired by the connection monitoring unit and receives a function selected from the list; and a function-screen display unit that displays information related to the error acquired by the function selected from the list.

### FIELD

The present invention relates to an engineering tool and more specifically to an engineering tool that searches for the cause of an error when the error has occurred in a PLC (Programmable Logic Controller) system.

### BACKGROUND

Conventionally, when an error occurs in a PLC system, the user of the PLC system uses a diagnosis function and a monitoring function of an engineering tool installed in a personal computer or the like, to search for and remove the error. A PLC system is a control system configured by connecting two or more PLCs via at least one network, or it is a control system configured from at least one PLC without being connected to a network.

For example, Patent Literature 1 discloses an invention that relates to an execution history display of a program and a technique in which, when an abnormal termination program or the like is specified, a list of functions related to a specified program is displayed and an operation execution of the function selected from the display is made to stand by. Patent Literature 2 discloses an invention that relates to a control display device and a technique in which the history of the occurrence of an abnormality or the like in a target device is stored and the history is displayed as a list in response to a request.

### CITATION LIST

### Patent Literatures

Patent Literature 1: Japanese Patent Application Laid-open No. H9-91173

Patent Literature 2: Japanese Patent Application Laid-open No. 2002-182889

### SUMMARY

### Technical Problem

A personal computer in which an engineering tool is installed therein is connected to a PLC via a USB cable or the like. A user activates the engineering tool on the personal computer connected to the PLC and starts up a plurality of functions for searching for a cause of an error, for example, functions of access point setup, data reading, monitoring, system diagnosis, and individual diagnosis of a unit. The user performs diagnosis and monitoring by using these functions to resolve the problem. According to such a conventional technique for searching for the cause of an error, there is a problem in that many operations with much time and labor by a user are required from the occurrence of an error to the resolving of the problem.

According to the technique disclosed in Patent Literature 1, a program having functions associated with a certain program is displayed as a list. Both techniques disclosed in Patent Literatures 1 and 2 are not related to functions addressing the state of the PLC that is a target device, such as a diagnosis function and a monitoring function. Therefore, it is difficult to resolve the above problem related to the search for a cause of an error.

The present invention has been achieved in view of the above problems, and an objective of the present invention is to provide an engineering tool that can search for the cause of an error in a PLC system by the user performing a simple operation.

### Solution to Problem

To solve the problem and achieve the objective mentioned above, the present invention relates to an engineering tool that includes: a connection monitoring unit that monitors presence of connection with a PLC constituting a PLC system, and, upon detection of connection with the PLC, acquires data related to a state of the PLC system; a function-selecting-screen display unit that displays a list of functions that can be used for searching for an error according to the state of the PLC system acquired by the connection monitoring unit and receives a function selected from the list; and a function-screen display unit that displays information related to the error acquired by the function selected from the list.

### Advantageous Effects of Invention

According to the present invention, in an engineering tool, a connection monitoring unit detects a connection with a PLC, and it acquires data related to the state of a PLC system including the PLC. The engineering tool displays a list of functions that can be used for searching for an error on a function-selecting-screen display unit. By connecting hardware installed with the engineering tool to the PLC by a user, the engineering tool automatically performs a presentation of functions that can be used for searching for the cause of the error. The user can start a diagnosis and monitoring of the error immediately by selecting a function from the list of functions. With this operation, the cause of the error in the PLC system can be searched for with a simple operation performed by the user.

### BRIEF DESCRIPTION OF DRAWINGS

FIG. 1 is a conceptual diagram explaining the operation and processing performed by an engineering tool according to a first embodiment of the present invention.

FIG. 2 is a block diagram illustrating a configuration for realizing an operation and processing in the engineering tool according to the first embodiment.

FIG. 3 is a diagram illustrating an example of management data held in a state/function supporting-data management unit.

FIG. 4 is a flowchart illustrating a procedure of an operation and processing of the engineering tool.

FIG. 5 is a diagram illustrating an example of a function selection screen.

FIG. 6 is a diagram illustrating an example of a diagnosis function screen.

FIG. 7 is a block diagram illustrating a configuration for realizing an operation and processing performed by an engineering tool according to a second embodiment of the present invention.

FIG. 8 is a diagram illustrating an example of management data held in a state/function supporting-data management unit.

FIG. 9 is a flowchart illustrating the procedure of an operation and processing of the engineering tool.

FIG. 10 is a diagram illustrating an example of a diagnosis function screen.

### DESCRIPTION OF EMBODIMENTS

Exemplary embodiments of an engineering tool according to the present invention will be explained below in detail with reference to the accompanying drawings. The present invention is not limited to the embodiments.

### First Embodiment

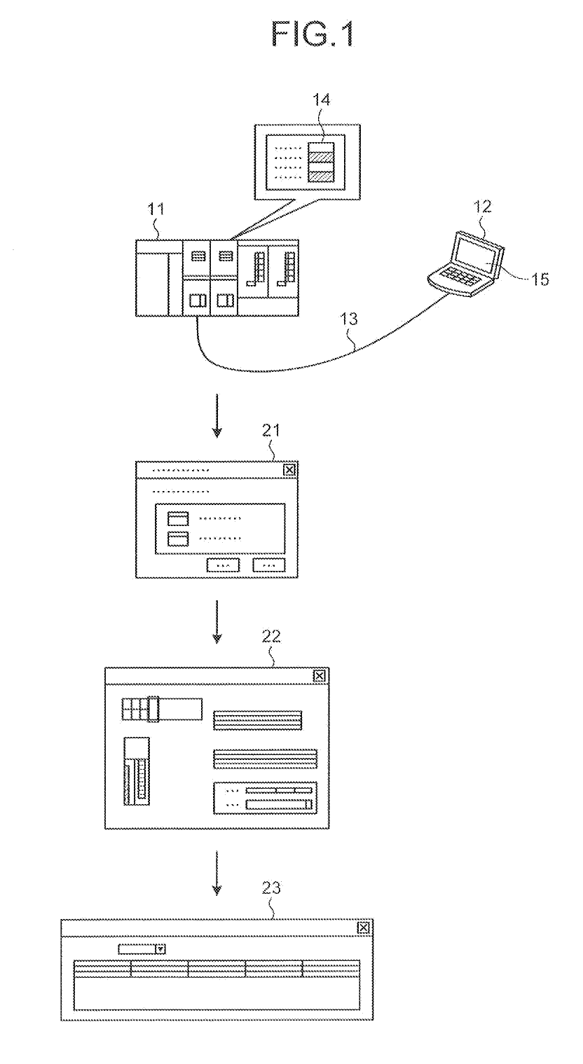

FIG. 1 is a conceptual diagram explaining the operation and processing performed by an engineering tool according to a first embodiment of the present invention. In the following embodiments, a PLC (Programmable Logic Controller) represents a device having mounted thereon a PLC CPU unit, an intelligent unit, a network unit, and the like on one base (and an additional unit). A PLC system represents a system in which one or more FA devices such as a PLC (Programmable Logic Controller) and a servo are connected to a network.

When a certain error occurs in the PLC system, a user of the PLC system recognizes the occurrence of the error by a notification unit provided in a PLC 11 constituting the PLC system, for example, lighting an LED 14.

A personal computer 12 is hardware in which the engineering tool is installed. Having recognized the occurrence of the error, the user connects the personal computer 12 to the PLC 11 constituting a PLC system 10 (a first user operation). A transmission unit such as a USB is used to connect the personal computer 12 with the PLC 11. A connection line 13 is, for example, a USB cable.

When the personal computer 12 is connected to the PLC 11, the engineering tool displays a function selection screen 21 on a display 15 of the personal computer 12. The function selection screen 21 includes a list displaying functions that can be used for searching for an error. The user selects a desired function from the function selection screen 21 (a second user operation).

When the user selects a function from the function selection screen 21, the engineering tool automatically sets up an access point for data communication and reading of data held in the PLC 11. The engineering tool displays a function screen on the display 15 by using the data acquired from the PLC 11.

The function screen is a screen corresponding to the function selected on the function selection screen 21. For example, when a diagnosis function is selected on the function selection screen 21, the engineering tool displays a diagnosis function screen 22 as the function screen. The user checks the error content, handling method, additional information, and the like on the diagnosis function screen 22 and appropriately corrects an erroneous part on an error-part correction screen. For example, when there is an error in a certain parameter, the engineering tool displays a parameter setting screen 23 as the erroneous part correction screen.

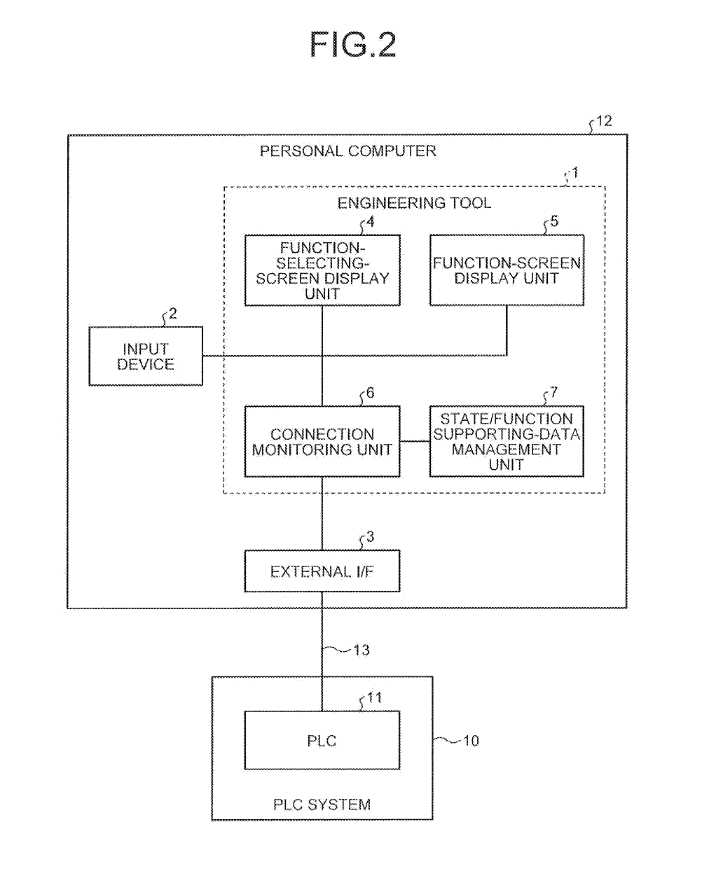

FIG. 2 is a block diagram illustrating a configuration for realizing an operation and processing in the engineering tool according to the first embodiment. An engineering tool 1 is realized by software on the personal computer 12. The personal computer 12 includes an input device 2 such as a keyboard and a mouse, an external interface (I/F) 3, and the display 15 (see FIG. 1). The external I/F 3 is connected to the PLC 11 via the connection line 13. The external I/F 3 receives an external input from the PLC 11. The external I/F 3 is, for example, a USB port.

A transmission unit other than a USB, a serial cable such as RS232C, for example, can be used for connecting the personal computer 12 and the PLC 11 together. The connection between the personal computer 12 and the PLC 11 can be wireless using, for example, a wireless LAN or Bluetooth®, instead of using cable communication via the connection line 13.

The engineering tool 1 includes a function-selecting-screen display unit 4, a function-screen display unit 5, a connection monitoring unit 6, and a state/function supporting-data management unit 7. The function-selecting-screen display unit 4 displays a list of functions that can be used for searching for an error on the function selection screen 21 according to the state of the PLC system 10 as acquired by the connection monitoring unit 6. The function-selecting-screen display unit 4 receives selection of functions from the list displayed on the function selection screen 21.

The function-screen display unit 5 displays information related to an error acquired by the function selected from the list on the function screen. The connection monitoring unit 6 monitors the presence of a connection with the PLC 11, which constitutes the PLC system 10. Upon detection of a connection with the PLC 11, the connection monitoring unit 6 acquires data on the state of the PLC system 10.

The state/function supporting-data management unit 7 holds management data in which the state of the PLC system 10 is associated with the functions of the engineering tool 1.

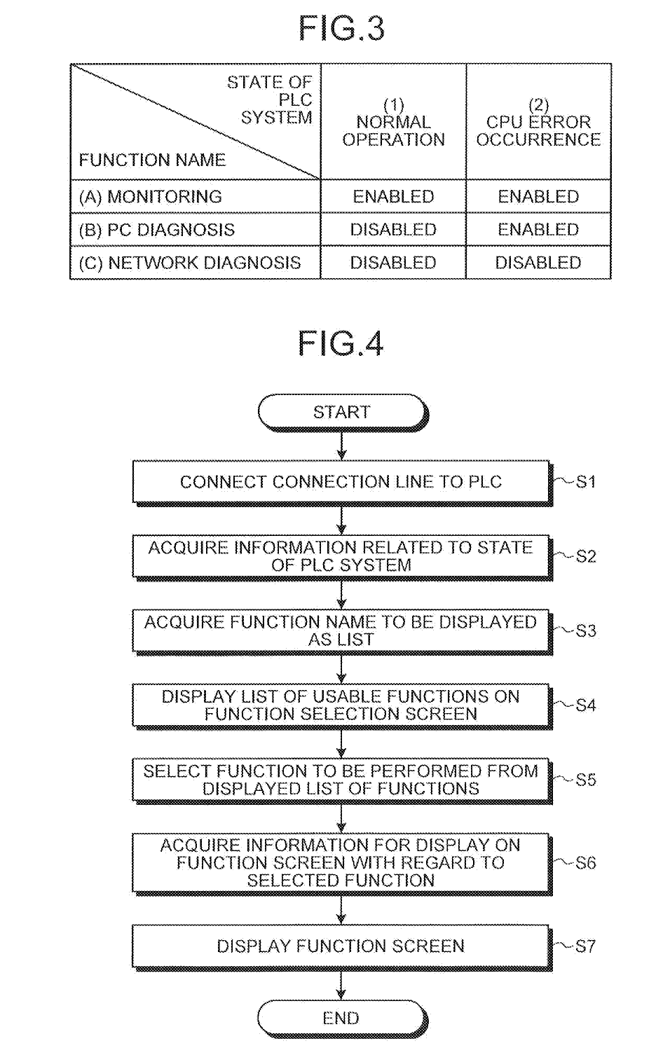

FIG. 3 is a diagram illustrating an example of management data held in the state/function supporting-data management unit. In a table of management data in which “function name” and “state of PLC system” are associated with each other, “enabled” indicates that the function having the function name is a selectable function in the state of the PLC system 10. “disabled” indicates that the function having the function name is a function that cannot be selected in the state of the PLC system 10.

In the management data illustrated in FIG. 3, “(A) monitoring” is a selectable function in both cases of “(1) normal operation” and “(2) CPU error occurrence”, which are states of the PLC system 10. “(B) PC diagnosis” is a function that cannot be selected when the state of the

PLC system 10 is “(1) normal operation”, but is a selectable function when the state thereof is “(2) CPU error occurrence”. “(C) network diagnosis” is a function that cannot be selected in both cases of “(1) normal operation” and “(2) CPU error occurrence”.

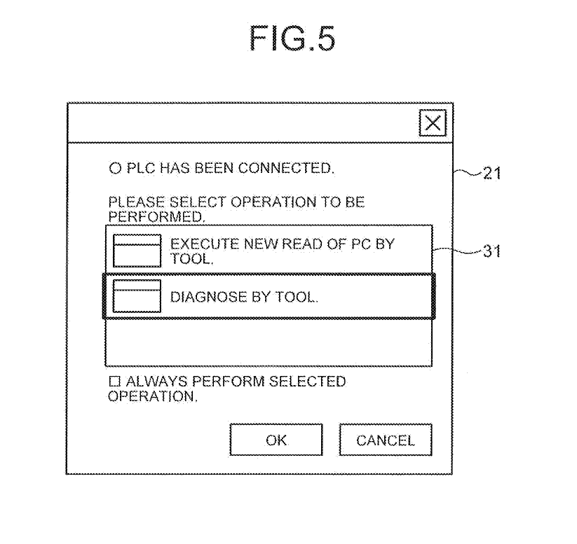

FIG. 4 is a flowchart illustrating a procedure of an operation and processing performed by the engineering tool. A user connects the connection line 13 connected to the external I/F 3 to the PLC 11 (Step S1). Step S1 is the first user operation. Upon detection of a connection with the PLC 11, the connection monitoring unit 6 acquires information on the state of the PLC system 10 including the PLC 11 from the PLC 11 (Step S2).

The connection monitoring unit 6 refers to management data in the state/function supporting-data management unit 7, thereby reading function names that can be selected with respect to the state of the PLC system 10 recognized at Step S2. With this processing, the connection monitoring unit 6 acquires the function names to be displayed in a list on the function-selecting-screen display unit 4 (Step S3).

For example, if it is assumed that the PLC 11 connected to the connection line 13 is itself in the state of a CPU error occurrence, then the connection monitoring unit 6 acquires function names being “enabled” with respect to “(2) CPU error occurrence” in the management data illustrated in FIG. 3, which are “(A) monitoring” and “(B) PC diagnosis”.

The function-selecting-screen display unit 4 displays the pieces of information of the functions acquired by the connection monitoring unit 6 at Step S3 on the function selection screen 21 as a list of usable functions (Step S4). The user selects a function to be performed from the list of functions displayed at Step S4 (Step S5). The user selects the function by operating the input device 2.

FIG. 5 is a diagram illustrating an example of a function selection screen. A selection dialogue 31 is displayed on the function selection screen 21 with messages: “PLC has been connected.” and “Please select operation to be performed.” In the selection dialogue 31, the respective functions are indicated as an explanation of an operation to be performed. The selection dialogue 31 corresponds to a list displaying of the functions. Selection of the operation by the user is received on the selection dialogue 31.

For example, “execute new read of PC by tool.” indicates an operation to perform “(A) monitoring”.

“diagnose by tool.” indicates an operation to perform “(B) PC diagnosis”. The user selects a function to be performed from the operations in the list of the selection dialogues 31. For example, the user specifies “diagnose by tool.” from the selection options of the selection dialogues 31 and then clicks “OK” to select the execution of “(B) PC diagnosis”. When the user checks a box at the beginning of the sentence “always perform selected operation”, the function selected once is always performed. In the selection dialogue 31, for example, function names can be displayed in a list other than in the display list of operations to be performed by the function.

The connection monitoring unit 6 acquires information for displaying on the function-screen display unit 5 with regard to the function selected at Step S5 (Step S6). For example, when “(B) PC diagnosis” is selected, the connection monitoring unit 6 acquires data from the PLC 11 for displaying on the diagnosis function screen 22 for when the function screen is “(B) PC diagnosis”. The connection monitoring unit 6 acquires information such as an error occurrence location in the PLC system 10, error content, and the handling method as the information for displaying on the diagnosis function screen 22.

The function-screen display unit 5 displays information acquired by the connection monitoring unit 6 at Step S6 on the function screen (Step S7). When the connection monitoring unit 6 acquires the information regarding “(B) PC diagnosis”, the function-screen display unit 5 displays the information acquired by the connection monitoring unit 6 on the diagnosis function screen 22. Data held in the engineering tool 1 in advance can be used as information on the handling method, which is to be displayed on the diagnosis function screen 22.

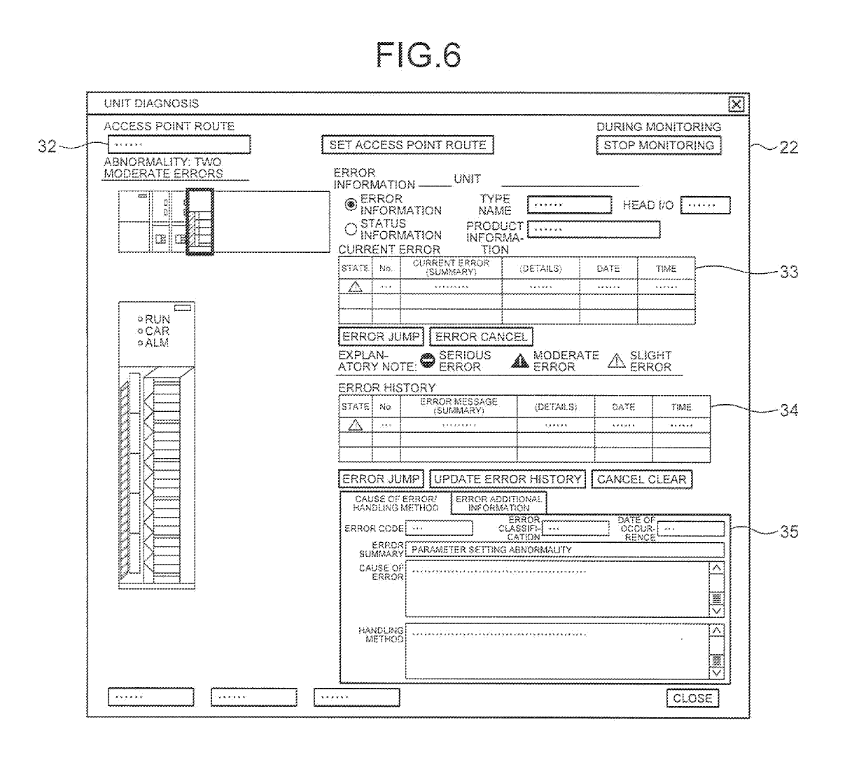

FIG. 6 is a diagram illustrating an example of a diagnosis function screen. In the column 32 headed “access point route” in the diagnosis function screen 22, information on the access point route of the engineering tool 1 (for example, “serial communication CPU connection (USB)” or the like) is displayed.

Information on a currently occurring error is displayed in a display column 33. In the display column 33, for example, under the item of “state”, the degree of the error is displayed by marks illustrated in an explanatory note. Under the item error number “No.”, the number given to the error is displayed. Under the item “current error”, an outline of the error content (for example, “PARAMETER ERROR”) and details thereof (for example, “slight error”) are displayed. In addition to these pieces of information, date and time data at which the error occurred is also displayed in the display column 33.

Historical information on errors that have occurred in the past is displayed in a display column 34. Items in the display column 34, for example, are similar to those in the display column 33. Pieces of information related to the cause and to the handling method of a currently occurring error and additional information related to the error are displayed in a display column 35. A user checks the pieces of information such as the error occurrence location in the PLC system 10, the error content, the handling method, and the like, on the diagnosis function screen 22.

For example, when the user selects any of currently occurring errors displayed in the display column 33 and presses an “error JUMP” icon displayed below the display column 33, the engineering tool 1 displays an error-part correction screen corresponding to the error. Also when the user selects an error from the history displayed in the display column 34 and presses the “error JUMP” icon displayed below the display column 34, the engineering tool 1 displays the error-part correction screen. The user corrects the error part on the error-part correction screen on the basis of information such as the handling method displayed on the diagnosis function screen 22.

For example, when the user selects an error due to an abnormal setting of parameters, the engineering tool 1 displays the parameter setting screen 23 (see FIG. 1) as the error-part correction screen. The user corrects the setting of parameters, as an erroneous part, on the parameter setting screen 23. The engineering tool 1 then completes a series of operations starting from the occurrence of an error to the resolution of the problem.

According to a conventional tool, a user sets up an access point and reading of data held in the PLC 11 after having detected an occurrence of an error and activating the tool. The user then searches for the cause of the error by appropriately causing various functions such as monitoring, system diagnosis, and individual diagnosis of the unit to work.

The engineering tool 1 according to the first embodiment automatically performs operations up to the presentation of functions usable for searching for the cause of an error by connecting hardware in which the engineering tool 1 is installed to the PLC 11. A user performs an operation to connect the hardware in which the engineering tool 1 is installed to the PLC 11 and an operation to select a function from a list. The user can then immediately search for the cause of an error by performing a simple operation. With this configuration, the cause of an error in the PLC system 10 can be searched for by the user performing a simple operation.

Note that when one function is acquired by the connection monitoring unit 6 at Step S3, the engineering tool 1 can omit the display of the list of functions at Step S4 and selection of functions at Step S5. In this case, the engineering tool 1 immediately acquires the information for displaying on the function-screen display unit 5 with regard to the one function (Step S6). Accordingly, the operation performed by the user can be further simplified.

Note that, in the processing for search and removal of errors, the engineering tool 1 is not limited to a case of receiving a signal relevant to the errors from the PLC 11. The engineering tool 1 can also receive a signal relevant to the errors from a display unit, a sensor, or the like connected to the PLC 11. Further, the engineering tool 1 can directly acquire a signal relevant to an error from a display unit, a sensor, or the like, which area devices other than the PLC 11.

### Second Embodiment

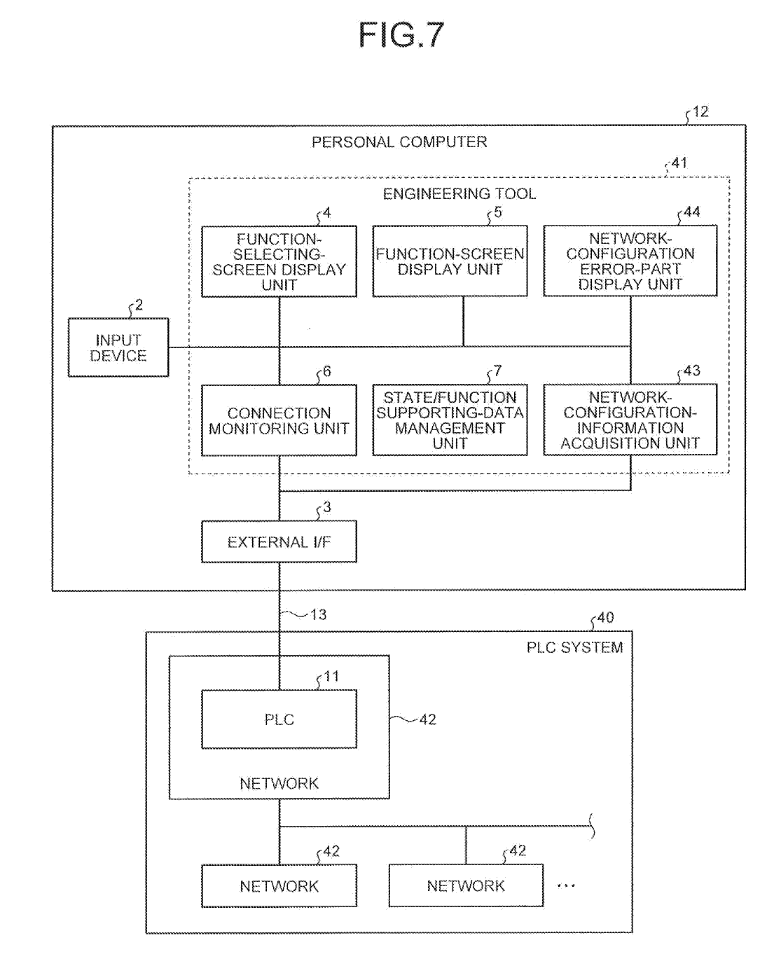

FIG. 7 is a block diagram illustrating a configuration for realizing an operation and processing performed by an engineering tool according to a second embodiment of the present invention. Parts identical to those of the first embodiment are denoted by like reference signs, and redundant explanations thereof are omitted as appropriate. A PLC system 40 is configured to include a plurality of networks 42.

An outline of an operation and processing performed by an engineering tool 41 according to the second embodiment is described here. Having recognized an occurrence of a certain error, a user connects the personal computer 12, which is the hardware in which the engineering tool 41 is installed, to the PLC 11 constituting the PLC system 40 (a first user operation). The PLC 11 to which the personal computer 12 is connected can be a PLC 11 on any of the networks 42.

When the personal computer 12 is connected to the PLC 11, the engineering tool 41 displays a function selection screen on the display 15 of the personal computer 12 (see FIG. 1). The displayed list of functions that can be used for searching for an error includes a network diagnosis function. The user selects a desired function from the function selection screen (a second user operation).

For example, when the user selects network diagnosis from the function selection screen, the engineering tool 41 acquires information on the network configuration of the PLC system 40 from the PLC 11.

The engineering tool 41 displays a network diagnosis screen on the display 15 on the basis of the information on the network configuration acquired from the PLC 11. If the user selects a function other than the network diagnosis, the engineering tool 41 performs processing identical to that of the engineering tool 1 according to the first embodiment.

The user selects the network 42 as a target of a network diagnosis from the network diagnosis screen (a third user operation). When the user selects the network 42, the engineering tool 41 automatically sets up an access point for data communication and reading of data held in the PLC 11. The engineering tool 41 displays the diagnosis function screen on the display 15 based on data acquired from the PLC 11. The user checks the error content, the handling method, additional information, and the like on the diagnosis function screen. The user then appropriately corrects an erroneous part on the error-part correction screen.

The engineering tool 41 is realized as software on the personal computer 12. As illustrated in FIG. 7, the engineering tool 41 includes the function-selecting-screen display unit 4, the function-screen display unit 5, the connection monitoring unit 6, the state/function supporting-data management unit 7, a network-configuration-information acquisition unit 43, and a network-configuration error-part display unit 44.

The network-configuration-information acquisition unit 43 acquires information on the configurations of the plurality of networks 42 in the PLC system 40. The network-configuration error-part display unit 44 displays the configurations of the networks 42 acquired by the network-configuration-information acquisition unit 43 and information related to errors in the networks 42. The network-configuration error-part display unit 44 receives the network 42 selected as the target of network diagnosis from the networks 42 on the network diagnosis screen.

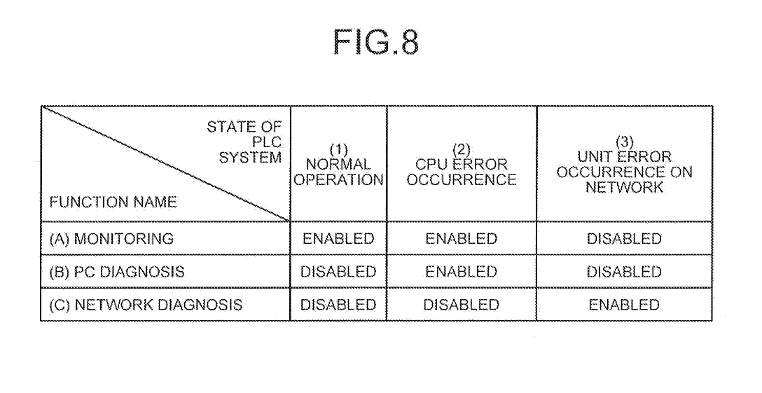

FIG. 8 is a diagram illustrating an example of management data held in the state/function supporting-data management unit. In a table of management data in which “function name” and “state of PLC system” are associated with each other, “enabled” indicates that the function having the function name is a selectable function in the state of the PLC system 40. “disabled” indicates that the function having the associated function name is a function that cannot be selected in the state of the PLC system 40.

In the management data illustrated in FIG. 8, “(3) unit error occurrence on network” is added as the state of the PLC system 40 to the content of the management data illustrated in FIG. 3. “(C) network diagnosis” is a selectable function when the state of the PLC system 40 is “(3) unit error occurrence on network”. When the state of the PLC system 40 is “(3) unit error occurrence on network”, “(A) monitoring” and “(B) PC diagnosis” are functions that cannot be selected.

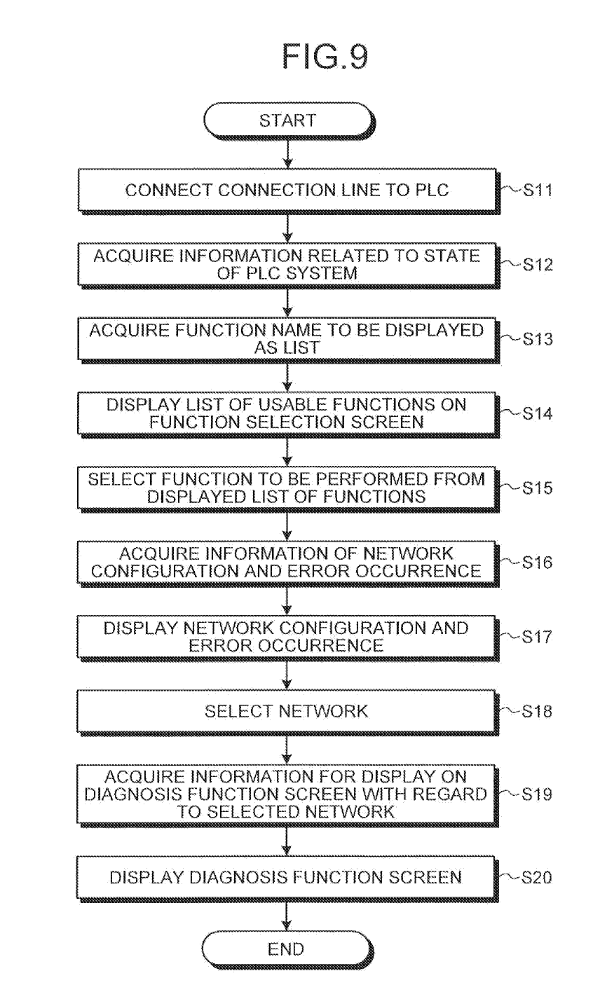

FIG. 9 is a flowchart illustrating a procedure of an operation and processing of the engineering tool. A user connects the connection line 13 connected to the external I/F 3 to the PLC 11 (Step S11). Step S11 is the first user operation. Upon detection of a connection with the PLC 11, the connection monitoring unit 6 acquires information on the state of the PLC system 40 including the PLC 11 from the PLC 11 (Step S12).

The connection monitoring unit 6 refers to management data in the state/function supporting-data management unit 7, thereby reading function names that can be selected with respect to the state of the PLC system 40 are recognized at Step S12. With this processing, the connection monitoring unit 6 acquires the function names to be displayed in a list on the function-selecting-screen display unit 4 (Step S13).

For example, if it is assumed that the PLC 11 in any of the networks 42 is in the state of “unit error occurrence on network”, then the connection monitoring unit 6 acquires the “enabled” function name “(C) network diagnosis” with respect to “(3) unit error occurrence on network” from the management data illustrated in FIG. 8.

The function-selecting-screen display unit 4 displays the pieces of information of the functions acquired by the connection monitoring unit 6 at Step S13 on the function selection screen 21 as a list of usable functions (Step S14). The user selects a function to be performed from the list of functions displayed at Step S14 (Step S15). The user selects a function by operating the input device 2. Step S15 is the second user operation.

If it is assumed that the user has selected the network diagnosis at Step S15, then the network-configuration-information acquisition unit 43 acquires the information on the configuration of the network 42 in the PLC system 40 and the information of an error occurrence state in the network 42 via the PLC 11 (Step S16).

Note that, because there is one selectable function, that is, “(C) network diagnosis” with regard to “(3) unit error occurrence on network”, the engineering tool 41 can omit the display of the list of functions at Step S14 and selection of functions at Step S15. In this case, the engineering tool 41 immediately acquires the information on the network configuration and the error occurrence state (Step S16). Accordingly, the operation by the user can be further simplified.

The network-configuration error-part display unit 44 displays the information acquired by the network-configuration-information acquisition unit 43 at Step S16 on a network diagnosis screen (Step S17). The user selects a network 42, for which network diagnosis is to be performed, from the network diagnosis screen (Step S18). The user selects the network 42 by operating the input device 2. Step S18 corresponds to the third user operation.

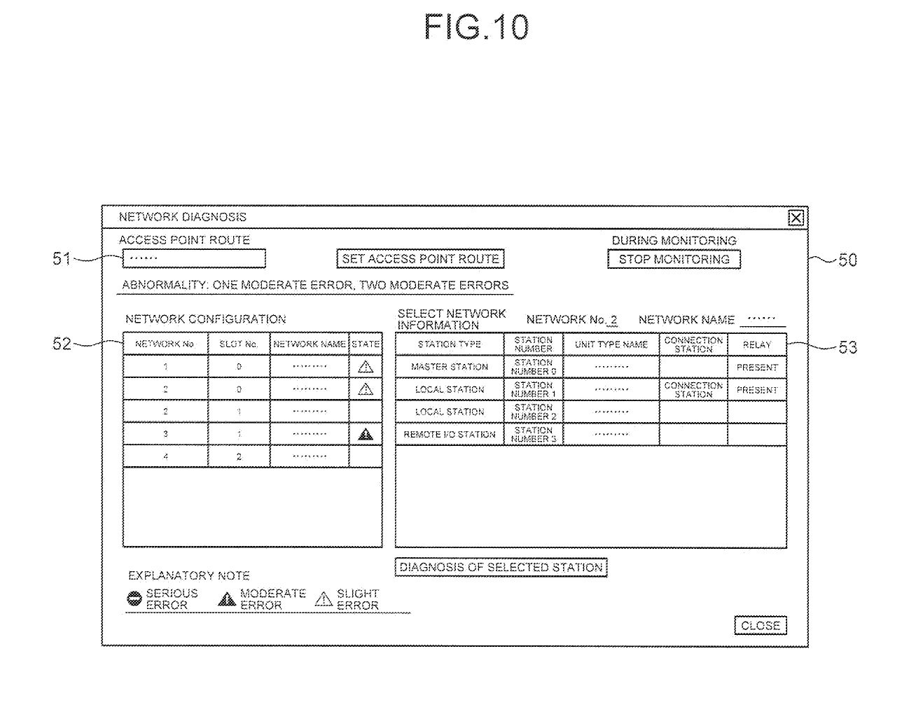

FIG. 10 is a diagram illustrating an example of a diagnosis function screen. In a column 51 of “access point route” in a network diagnosis screen 50, information on the access point route of the engineering tool 41 (for example, “serial communication CPU connection (USB)” or the like) is displayed.

Information on the configuration of the network 42 is displayed in a display column 52. Respective items, for example, a network number, a slot number, and a network name, are displayed in the display column 52 with regard to the respective networks 42 constituting the PLC system 40. Information on the error occurrence state in the respective networks 42 is displayed under an item of “state”. A mark indicating a degree of the error is added, as illustrated, in an explanatory note with regard to the network 42 in which the error has occurred.

When a user selects any of the networks 42 displayed on the display column 52, detailed information on the configuration of the selected network 42 is displayed in a display column 53. When the user presses an icon for “diagnosis of selected station” displayed below the display column 53, the connection monitoring unit 6 acquires data for displaying on the diagnosis function screen from the PLC system 40 with regard to the network 42 selected at Step S18 (Step S19).

The function-screen display unit 5 displays information acquired by the connection monitoring unit 6 on the diagnosis function screen (Step S20). The user corrects an erroneous part on the error-part correction screen according to the information, such as the handling method, displayed on the diagnosis function screen. The engineering tool 41 then finishes a series of operations starting from the occurrence of the error to resolution of the problem.

The engineering tool 41 according to the second embodiment displays information of the network configuration by connecting hardware in which the engineering tool 41 is installed with the PLC system 40 and selecting the network diagnosis function. A user selects the network 42 as the target of network diagnosis from the display of the network configuration. The user can immediately search for an error occurring in any of the networks 42 by performing a simple operation.

According to a conventional tool, if there is an error in the PLC 11 in any one of the plurality of the networks 42, an operation of searching for the network 42 in which an error has occurred is required. According to the engineering tool 41 of the second embodiment, the user can perform diagnosis on the respective networks 42 by connecting the engineering tool 41 to a sequencer 11 that is present in the vicinity thereof. The user can easily perform diagnosis also for the sequencer 11 installed at a distant position from the user's own current position. With this configuration, the diagnosis time can be shortened, and the cause of an error can be searched for by the user performing a simple operation.

Note that, in the processing for search and removal of errors, the engineering tool 41 is not limited to a case of receiving a signal relevant to the errors from the PLC 11. The engineering tool 41 can also receive a signal relevant to the error from a display unit, a sensor, or the like connected to the PLC 11. Further, the engineering tool 41 can directly acquire a signal relevant to the errors from a display unit, a sensor, or the like, which are devices other than the PLC 11.

### REFERENCE SIGNS LIST

1 engineering tool, 2 input device, 4 function-selecting-screen display unit, 5 function-screen display unit, 6 connection monitoring unit, 7 state/function supporting-data management unit, 10 PLC system, 11 PLC, 12 personal computer, 13 connection line, 15 display, 21 function selection screen, 22 diagnosis function screen, 23 parameter setting screen, 31 selection dialogue, 32 column, 33, 34, 35 display column, 40 PLC system, 41 engineering tool, 42 network, 43 network-configuration-information acquisition unit, 44 network-configuration error-part display unit, 50 network diagnosis screen, 51 column, 52, 53 display column.

1. An engineering tool comprising:
a connection monitoring unit that
monitors presence of connection with a PLC (Programmable Logic Controller) constituting a PLC system, and,
upon detection of connection with the PLC, acquires data related to a state of the PLC system;
a state/function supporting-data management unit that holds management data in which the state of the PLC system is associated with functions of the engineering tool;
a function-selecting-screen display unit that displays a list of functions that can be used for searching for a cause of an error according to a state of the PLC system acquired by the connection monitoring unit and receives a function selected from the list; and
a function-screen display unit that displays information related to the cause of the error acquired by the function selected from the list, wherein
the connection monitoring unit reads a function name indicating a function of the engineering tool corresponding to the state of the PLC system acquired after the connection has been detected, by referring to the management data, so as to acquire a function name to be displayed as the list on the function-selecting-screen display unit, and
upon selection of a function from the list, the connection monitoring unit acquires data for displaying on the function-screen display unit with regard to the selected function.

2. (canceled)

3. The engineering tool according to claim 1, wherein
the PLC system is configured to include a plurality of networks,
the engineering tool further comprises:
a network-configuration-information acquisition unit that acquires information about configurations of the plurality of networks; and
a network-configuration error-part display unit that displays information related to the configurations of the networks acquired by the network-configuration-information acquisition unit and the error in the networks, wherein
when a function of network diagnosis is selected from the list on the function-selecting-screen display unit, the network-configuration-information acquisition unit acquires information related to the configurations of the networks, and
the network-configuration error-part display unit receives a network selected as a target of the network diagnosis from among the plurality of networks.
